(19) United States
(12) Patent Application Publication
(10) Pub. No.: US 2010/0194598 A1
(43) Pub. Date: Aug. 5, 2010

(54) Arrangement for Transmitting Information Concerning an Operating Condition of a Vehicle

(75) Inventor: Hans L. TRAUTENBERG, Ottobrunn (DE)

Correspondence Address: CROWELL & MORING LLP;INTELLECTUAL PROPERTY GROUP, P.O. BOX 14300, WASHINGTON, DC, 20044-4300, US

(73) Assignee: Astrium GmbH, Taufkirchen (DE)

(21) Appl. No.: 12/695,665

(22) Filed: Jan. 28, 2010

(30) Foreign Application Priority Data
Jan. 30, 2009 (DE) 10 2009 006 830.9

(51) Int. Cl. G08B 21/00

(52) U.S. Cl. 340/945

(57) ABSTRACT

An arrangement for transmitting information concerning an operating condition of a vehicle, such as an aircraft or spacecraft, exerts tactile stimuli as information via a stimulus generator on at least one operator of the vehicle. The stimulus is exerted on a sense organ or body part of the operator that is not used for active transmission of information during trouble-free and proper operation of the vehicle.

This application claims the priority of German patent application 10 2009 006 830.9-22, filed Jan. 30, 2009, the disclosure of which is expressly incorporated by reference herein.

The present invention relates an arrangement for conveying information concerning the operating condition of a vehicle, by exerting tactile stimuli on at least one operator of the vehicle, by means of a stimulus generator. Such an arrangement is suitable particularly for aircraft and spacecraft.

### BACKGROUND OF THE INVENTION

Acoustic signals, visual displays and shaking of operating elements are normally used in an aircraft for transmitting information to the operator. A known device for transmitting tactile stimuli to the operator is, for example, the so-called “stick shaker”, by means of which a shaking motion is exerted on the control stick of the airplane shortly before a critical angle of attack is reached, at which there is the danger of a stall at the wings. The pilot's attention is thereby drawn to the imminence of the stall which would initially also cause shaking motions of the airplane.

A similar measure for the tactile stimulus transmission to the operator of a vehicle is known from automotive engineering, where vibration of the brake pedal is generated when the ABS intervenes in order to draw the driver's attention to the critical braking condition of his vehicle.

In these two examples, the stimulus is transmitted from the machine to the part of the operator's body that carries out the operation: specifically to the airplane pilot's hand operating the control stick or the automobile driver's foot operating the brake pedal. As a result of the additional artificial exertion of stimuli, however, the operator's sensitivity with respect to the actually required operation of the control stick or of the brake pedal is reduced in both cases.

Furthermore, in the case of aircraft, a large volume of information and warning messages also affect the pilot visually or acoustically. In U.S. Pat. No. 7,403,133 B2, for example, additional visual warning indications are inserted in the display instruments used for controlling and/or navigating the airplane, in order, for example, to indicate unusual angles of attack or attitudes.

Particularly in an airplane, a large amount of visual and acoustic information is conveyed to the operating personnel, so that frequently, even in the normal operation of the aircraft, there is the risk of a visual or acoustic inundation with stimuli. When additional visual or acoustic stimuli also act upon the operating personnel in such a situation, there is the latent danger that warning indications are not perceived quickly enough or with the required priority as a result of the already existing high stimulus effect on the operating personnel.

### SUMMARY OF THE INVENTION

It is therefore an object of the present invention to provide an arrangement for conveying information concerning the operating condition of a vehicle, (particularly an aircraft or spacecraft) which permits an improved perception of information, particularly in critical operating conditions.

This and other objects and advantages are achieved by the information conveying arrangement according to the invention, in which stimuli are exerted on an operator's sense organ or body part that is not used for the active receipt of information during a trouble-free and proper operation of the vehicle. The perceptibility of the additionally transmitted information is thus improved, because a sensor of the operator that is not yet used for transmission of other information is used to signal this additionally transmitted information. The operator's senses are therefore not subject to the initially described risk of inundation with stimuli, and inundation of the operator's other body parts or senses with stimuli is therefore prevented, because a stimulus, sense or organ that is not otherwise used for the transmission of information is used to transmit this additional critical information.

The exertion of stimuli preferably takes place on the operator's back and/or his or her posterior region. As an alternative or in addition, the stimulus may also be exerted on the operator's stomach region or a leg region (for example, on his or her thigh). In this manner, the stimulus is introduced into the operator's trunk.

When used in an aircraft in an operating condition reflecting the angle of attack or another attitude, the effect of the stimulus on the trunk corresponds precisely to the feeling that the pilot perceives when the airplane is about to stall. In this phase, in which the flow around the wing, starting at the root of the wing, stops flowing around the wing, the plane experiences severe shaking and vibrations. However, according to the invention these vibrations are transmitted to the pilot before the beginning of the stall, by means of the stimulus generator. As a result, the pilot will instinctively initiate countermeasures in time before the stall at the wing actually starts.

A similar use of the arrangement according to the invention can, for example, also be provided in a motor vehicle, where, by means of a corresponding application of tactile stimuli acting upon the driver's trunk by way of the driver seat, the driver can be warned in critical driving situations before a swerving of the vehicle while cornering.

The stimulus preferably is a vibration stimulus. However, as an alternative or in addition, it may be an electric stimulus and/or or a pressure stimulus.

In a preferred embodiment, the stimulus generator is provided in the seat for the operator.

As an alternative or in addition, the stimulus generator can be provided in the operator's clothing or can be provided in such a manner that it acts by way of active devices in the operator's clothing.

The stimulus generator, which preferably comprises at least one vibration generator installed in the seat for the operator, may be constructed to generate the vibration electromechanically, electropneumatically or electrohydraulically.

In an embodiment particularly suitable for military aviation, the stimulus generator generates vibrations in the form of high-pressure fluid fluctuations, which act upon high-pressure fluid chambers in the operator's clothing. Therefore, when the pilot is, for example, wearing a G-suit, information can be transmitted to him or her by a vibration of the fluid pressure in the G-suit or by a rise of the pressure in the G-suit, so that he or she has an increasing or alternating feeling of tightness in the G-suit.

In another preferred embodiment, the stimulus generator may have at least one voltage generator or voltage transformer for generating an electric stimulus current, and at least one pair of electrodes by which the electric stimulus current acts upon the operator's skin. By means of voltages and current intensities which are harmless with respect to health, a prickling sensation can thereby be generated in the operator's skin, which draws the operator's attention to the special operating condition of the vehicle.

The intensity of the stimulus preferably rises when the operating condition of the vehicle becomes more critical. In this manner, the operator's attention can be drawn to an imminent critical operating condition at an early stage, by means of a very low stimulus level. When the danger potential of the operating condition then rises, the intensity of the stimulus can be increased in order to indicate the increasing danger to the operator by means of an increasing stimulus effect.

Other objects, advantages and novel features of the present invention will become apparent from the following detailed description of the invention when considered in conjunction with the accompanying drawings.

### BRIEF DESCRIPTION OF THE DRAWINGS

FIG. 1 shows the connection of a vehicle seat equipped with a stimulus generator to an electronic system of the vehicle; and

FIG. 2 shows the coupling of a G-suit to an onboard computer of an aircraft.

### DETAILED DESCRIPTION OF THE DRAWINGS

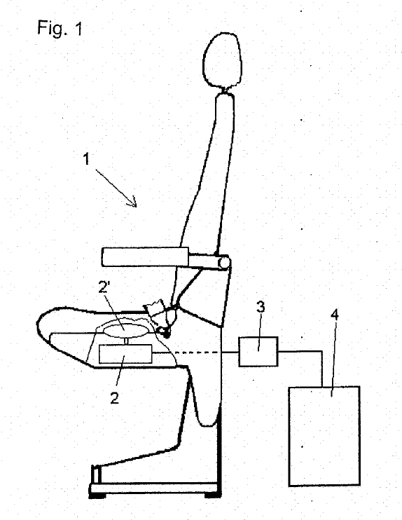

FIG. 1 is a schematic view of an airplane seat 1 with a vibration generator 2 illustrated as the stimulus generator, below the seat surface. The vibration generator 2 may, for example, have an eccentric which is driven by an electric motor, which eccentric, in turn, acts upon a thrust body 2′ acting from below against the seat surface of the airplane seat 1.

The vibration generator 2 is connected with a control unit 3, which controls the generation of the stimulus, and is connected, in turn, with the onboard computer 4 of the airplane for exchanging data.

As soon as the onboard computer determines that a critical flight condition is imminent, it sends corresponding information to the control unit 3, which activates the vibration generator 2 to generate the stimulus.

Such critical operating conditions may, for example, be an excessive angle of attack (about the pitch axis of the airplane), an excessive roll angle (about the roll axis of the airplane) or an excessive angle of yaw (about the yaw axis of the vehicle). A combination of the attack, roll and/or yaw angles can also result in an activation of the vibration generator 2 when a stall is imminent.

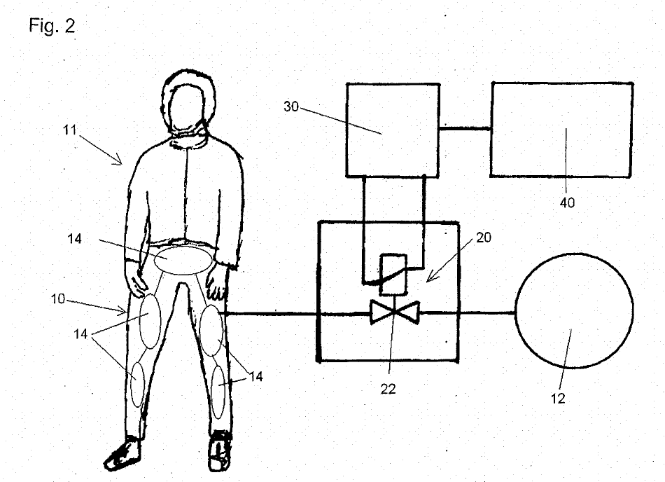

Another embodiment of the present invention, illustrated in FIG. 2, can be used particularly when the pilot is wearing a G-suit or so-called anti-G trousers. This functional clothing contains airtight pockets into which a fluid under pressure, such as compressed air, is introduced in order to expose the pilot's body to external pressure, and to prevent, at high acceleration, blood from being pressed from the brain into the trunk and/or the legs, such as can result in the pilot's light-headedness.

According to the invention, a stimulus generator 20 is integrated in the compressed-air supply for such a G-suit or such an anti-G suit, which stimulus generator 20 has, for example, a fast-opening and fast-closing valve 22. This valve 22 (which may be a solenoid valve) is acted upon in a fast synchronization by a corresponding control unit 30 for generating the stimulus. The control unit 30 is connected with the onboard computer 40 of the aircraft, so that the valve opens and closes at a high frequency and therefore generates pressure thrusts in the high-pressure fluid guided from the compressed-air source 12 into the chambers 14 of the G-suit 10. Such pressure thrusts can be perceived by the pilot 11 as a vibration. The pressure can also be increased continuously when the danger increases on which the signaling is based.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE NUMBERS

1 Airplane seat
2 Vibration generator
2′ Thrust body
3 Control unit
4 Onboard computer
10 G-Suit
11 Pilot
12 Compressed-air source
14 Chamber
20 Stimulus generator
22 Valve
30 Control unit
40 Onboard computer

What is claimed is:

1. Apparatus for conveying information concerning the operating condition of a vehicle by exerting tactile stimuli via a stimulus generator on at least one operator of the vehicle, wherein the stimulus is exerted on a sense organ or body part of the operator that is not used for active transmission of information during trouble-free and proper operation of the vehicle.

2. The apparatus according to claim 1, wherein the vehicle is one of an aircraft and a spacecraft.

3. The arrangement according to claim 1, wherein the stimulus is exerted on one of the operator's back, the operator's posterior region, operator's stomach region, and the operator's leg region.

4. The arrangement according to claim 1, wherein the stimulus is a vibration.

5. The arrangement according to claim 1, wherein the stimulus is an electric stimulus.

6. The arrangement according to claim 1, wherein the stimulus is a pressure.

7. The arrangement according to claim 1, wherein the stimulus generator is disposed in the seat for the operator.

8. The arrangement according to claim 1, wherein the stimulus generator is provided in the operator's clothing.

9. The arrangement according to claim 1, wherein the stimulus generator acts in the operator's clothing, via active devices.

10. The arrangement according to claim 1, wherein:
the vehicle comprises one of an aircraft and a spacecraft; and
the information transmitted by the tactile stimulus relates to a condition of the aircraft or spacecraft shortly before reaching a critical attitude.

11. The arrangement according to claim 1, wherein the stimulus generator comprises at least one vibration generator arranged in a vehicle seat of the operator.

12. The arrangement according to claim 11, wherein the vibration generator is one of electromechanic, electropneumatic and electrohydraulical.

13. The arrangement according to claim 1, wherein the stimulus generator comprises at least one vibration generator which generates vibrations in the form of high-pressure fluid fluctuations, which act on high-pressure fluid chambers in the operator's clothing.

14. The arrangement according to claim 1, wherein the stimulus generator has at least one voltage component for generating an electric stimulus, and at least one pair of electrodes, through which the electric stimulus acts upon the operator's skin.

15. The arrangement according to claim 1, wherein intensity of the stimulus increases as the operating condition of the vehicle becomes more critical.
